(19) United States
(12) Patent Application Publication
(10) Pub. No.: US 2018/0332697 A1
(43) Pub. Date: Nov. 15, 2018

(54) TORCHES AND SYSTEMS AND METHODS USING THEM

(71) Applicant: PERKINELMER HEALTH SCIENCES CANADA, INC., Woodbridge (CA)

(72) Inventors: Samad Bazargan, Brampton (CA); Brian Chan, Markham (CA); Serguei Savtchenko, Woodbridge (CA); Hamid Badiei, Woodbridge (CA)

(21) Appl. No.: 15/948,078

(22) Filed: Apr. 9, 2018

Related U.S. Application Data
(60) Provisional application No. 62/483,739, filed on Apr. 10, 2017.

(51) Int. Cl. H05H 1/28; H05H 1/30

(52) U.S. Cl. CPC H05H 1/28; H01J 49/105; H05H 1/30

(57) ABSTRACT

Certain configurations of a torch are described which can be used to sustain a plasma using lower powers and lower cooling gas flow rates. In some examples, the torch may comprise an inner tube of variable diameter along a longitudinal length with a selected gap between outer surfaces of a terminal end or third section of the inner tube and inner surfaces of the outer tube. The terminal end length and/or gap distance can be selected to sustain a concentric plasma using the torch and one or more induction devices. Methods and systems using the torch are also described.

### PRIORITY APPLICATION

This application is related to and claims priority to and the benefit of U.S. Provisional Application No. 62/483,739 filed on Apr. 10, 2017, the entire disclosure of which is hereby incorporated herein by reference.

### TECHNOLOGICAL FIELD

Certain configurations described herein are directed to torches. More particularly, certain configurations described herein are directed to torches which can sustain a plasma using lower argon flow rates than conventional torches.

### BACKGROUND

Conventional torches used to sustain a plasma may operate at argon flow rates exceeding 20 liters per minute. In addition, high powers are often used with these high argon flow rates to sustain a stable plasma.

### SUMMARY

Certain aspects are described below of plasma torches which may provide stable plasmas at low argon flow rates and/or low radio frequency powers.

In one aspect, a torch configured to sustain an ionization source is described. In some configurations, the torch comprises an outer tube comprising an inlet, an outlet and at least one cooling gas slot adjacent to the inlet of the outer tube. In certain examples, the torch comprises an inner tube positioned within the outer tube. In some configurations, the inner tube further comprises a first section coupled to a second section and a third section coupled to the second section. In some instances, the first section is positioned adjacent to the inlet of the outer tube and the third section is positioned downstream from the second section toward the outlet of the outer tube and the second section is between the first section and the third section. In certain embodiments, an outer diameter of the first section and the third section are substantially constant in a longitudinal direction. In some examples, an outer diameter of the second section increases in the longitudinal direction from the first section toward the third section. In certain configurations, a distance between an outer surface of the third section of the inner tube and an inner surface of the outer tube is less than 1 mm.

In certain examples, the second section comprises a substantially symmetric radial cross-section along the longitudinal length. In other embodiments, the outer tube comprises a second cooling gas slot, e.g., one which may be positioned in a same or different radial plane as the first cooling gas slot. In some examples, the outer diameter of the third section is greater than the outer diameter of the first section. In some embodiments, a longitudinal length of the third section is 25 mm or less. In certain examples, a longitudinal length of the third section is between 5 mm and 25 mm or is 5 mm or less. In some examples, a longitudinal length of the third section is 5 mm or less and the distance between the outer surface of the third section and the inner surface of the outer tube is 0.5 mm or less. In some examples, a longitudinal length of the third section is selected to provide a concentric inductively coupled plasma in the torch. In certain embodiments, a distance between the cooling gas slot and the outlet of the outer tube is between 25 mm and 80 mm. In some examples, the outer diameter of the second section increases from a first end adjacent to the first section to a second end adjacent to the third section. In certain instances, the outer diameter of the second section is about 12 mm at the first end and about 17 mm at the second end. In other examples, a longitudinal length of the third section is about 25 mm or less. In some embodiments, the distance between the outer surface of the third section and the inner surface of the outer tube varies along a longitudinal length of the third section. In certain examples, the first section is about 35 mm to about 55 mm in length and comprises an outer diameter of about 10 mm to about 16 mm, the third section is about 5 mm to about 25 mm in length and comprises an outer diameter of about 16 mm to about 18 mm, and the second section comprises a length of about 4 mm to about 20 mm.

In another aspect, a system comprises an induction device, and a torch positioned within an aperture of the induction device. In some examples, the torch comprises an inner tube positioned within an outer tube. For example, the outer tube comprises an inlet and an outlet and at least one cooling gas slot adjacent to the inlet of the outer tube. In other examples, the inner tube further comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section. In some instances, an outer diameter of the first section and the third section are substantially constant in a longitudinal direction. In other examples, an outer diameter of the second section increases in the longitudinal direction from the first section toward the third section. In certain embodiments, a distance between an outer surface of the third section and an inner surface of the outer tube is less than 1 mm.

In some embodiments, the system comprises a sample introduction device fluidically coupled to the torch. In other embodiments, the sample introduction device comprises an atomizer or a nebulizer. In certain examples, the system comprises a detector fluidically coupled to the torch. In certain instances, the detector comprises an optical detector, an electron multiplier, a Faraday cup or a scintillation plate. In some examples, the induction device comprises an induction coil. In certain examples, the induction device comprises at least one plate. In some embodiments, the induction device comprises an induction coil comprising at least one radial fin. In certain examples, the torch further comprises a second cooling gas slot. In some examples, the first section is about 35 mm to about 55 mm in length and comprises an outer diameter of about 10 mm to about 16 mm, the third section is about 5 mm to about 25 mm in length and comprises an outer diameter of about 16 mm to about 18 mm, and the second section comprises a length of about 4 mm to about 20 mm.

In another aspect, a mass spectrometer comprises a torch and a mass analyzer fluidically coupled to the torch. In some examples, the torch comprises an inner tube positioned within an outer tube, the outer tube comprising an inlet and an outlet and at least one cooling gas slot adjacent to the inlet of the outer tube. In some examples, the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section. In some configurations, an outer diameter of the first section and the third section are substantially constant in a longitudinal direction. In some instances, an outer diameter of the second section increases in the longitudinal direction from the first section toward the third section. In some configurations, a distance between an outer surface of the third section and an inner surface of the outer tube is less than 1 mm.

In certain examples, the mass spectrometer comprises a sample introduction device fluidically coupled to the torch. In some instances, the sample introduction device comprises an atomizer or a nebulizer. In other examples, the mass spectrometer comprises a detector fluidically coupled to the mass analyzer. In certain examples, the detector comprises an electron multiplier, a Faraday cup, a multi-channel plate or a scintillation plate. In some instances, the mass spectrometer comprises an induction device comprising an aperture configured to receive a portion of the torch to provide radio frequency energy into the received portion to sustain a plasma within the torch. In some examples, the induction device comprises an induction coil. In other examples, the induction device comprises at least one plate. In further examples, the induction device comprises an induction coil comprising at least one radial fin. In some embodiments, the torch further comprises a second cooling gas slot.

In an additional aspect, an optical emission spectrometer comprises a torch and a detector configured to detect optical emissions of analyte species introduced into the torch. In some configurations, the torch comprises an inner tube positioned within an outer tube, the outer tube comprising an inlet and an outlet and at least one cooling gas slot adjacent to the inlet of the outer tube. In other configurations, the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section. In some examples, an outer diameter of the first section and the third section are substantially constant in a longitudinal direction. In some embodiments, an outer diameter of the second section increases in the longitudinal direction from the first section toward the third section. In other examples, a distance between an outer surface of the third section and an inner surface of the outer tube is less than 1 mm.

In certain configurations, the optical emission spectrometer comprises a sample introduction device fluidically coupled to the torch. In some examples, the sample introduction device comprises an atomizer or a nebulizer. In certain examples, the detector is configured to detect axial optical emission from the analyte species introduced into the torch. In other examples, the detector comprises a photomultiplier tube. In some configurations, the optical emission spectrometer comprises an induction device comprising an aperture configured to receive a portion of the torch to provide radio frequency energy into the received portion to sustain a plasma within the torch. In some embodiments, the induction device comprises an induction coil. In certain examples, the induction device comprises at least one plate. In other examples, the induction device comprises an induction coil comprising at least one radial fin. In some examples, the torch further comprises a second cooling gas slot.

In an additional aspect, an atomic absorption spectrometer comprises a torch, a light source configured to provide light to the torch, and a detector configured to detect absorption of the light provided to the torch by analyte species introduced into the torch. In some examples, the torch comprises an inner tube positioned within an outer tube, the outer tube comprising an inlet and an outlet and at least one cooling gas slot adjacent to the inlet of the outer tube. In other configurations, the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section. In some embodiments, an outer diameter of the first section and the third section are substantially constant in a longitudinal direction. In other embodiments, an outer diameter of the second section increases in the longitudinal direction from the first section toward the third section. In other examples, a distance between an outer surface of the third section and an inner surface of the outer tube is less than 1 mm.

In certain configurations, the atomic absorption spectrometer comprises a sample introduction device fluidically coupled to the torch. In some instances, the sample introduction device comprises an atomizer or a nebulizer. In other examples, the light source is configured to provide the light axially to the torch. In some examples, the detector comprises a photomultiplier tube. In other examples, the atomic absorption spectrometer comprises an induction device comprising an aperture configured to receive a portion of the torch to provide radio frequency energy into the received portion to sustain a plasma within the torch. For example, the induction device comprises an induction coil or at least one plate or an induction coil comprising at least one radial fin. In some embodiments, the torch further comprises a second cooling gas slot.

In another aspect, a method of sustaining an ionization source in a torch using a cooling gas flow of 10 Liters/minute or less is described. In some examples, the method comprises providing radio frequency energy into a torch from an induction device to sustain the ionization source in the torch at the cooling gas flow rate of 10 Liters/minute or less. In some configurations, the torch comprises an inner tube positioned within an outer tube, the outer tube comprising an inlet and an outlet and at least one cooling gas slot adjacent to the inlet of the outer tube. In some examples, the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section. In certain examples, an outer diameter of the first section and the third section are substantially constant in a longitudinal direction. In other examples, an outer diameter of the second section increases in the longitudinal direction from the first section toward the third section. In further examples, a distance between an outer surface of the third section and an inner surface of the outer tube is less than 1 mm.

In certain embodiments, the method comprises providing the radio frequency energy into the torch at a power up to about 1400 Watts. In some examples, the method comprises configuring the outer tube with a second cooling gas slot to sustain a substantially concentric plasma within the torch, wherein the total cooling gas flow rate introduced into the first and second cooling gas slots is 10 Liters/minute or less. In other examples, the method comprises concentrically introducing the cooling gas, e.g., argon cooling gas, into the first and second cooling gas slots. In some examples, the method comprises introducing the cooling gas into the second cooling gas slot after the plasma is ignited in the torch. In certain examples, the method comprises introducing a cooling gas of a different composition into the second cooling gas slot than a composition of a cooling gas introduced into the first cooling gas slot. In some examples, the method comprises configuring the distance between the outer surface of the third section and an inner surface of the outer tube to be between 0.2 mm and 0.5 mm. In certain configurations, the method comprises configuring the outer diameter of the second section to increase from a first end adjacent to the first section to a second end adjacent to the third section. In some embodiments, the method comprises altering a composition of the cooling gas after the plasma is ignited. In some examples, the method comprises reducing the cooling gas flow to 8 liters/minute or less after the plasma is ignited. In some embodiments, the method comprises configuring the distance between the outer surface of the third section and an inner surface of the outer tube to be 0.5 mm or less and reducing the cooling gas flow to 5 Liters/minute or less after the plasma is ignited. In some examples, the method comprises configuring an outer diameter of the second section to increase from a first end to a second end, wherein the first end is coupled to the first section of the inner tube and the second end is coupled to the third section of the inner tube, and wherein the outer diameter increases by about 5% to about 20% per 1 mm of longitudinal length of the second section. In other examples, the method comprises sustaining the plasma in the torch using a total argon flow of less than 12 Liters/minute or less than 11 Liters/minute or less than 10 Liters/minute. In some examples, the method comprises altering a composition of the gas flows into the torch after the plasma is ignited. In certain embodiments, the method comprises simultaneously reducing argon gas flow into the torch after the plasma is ignited and increasing nitrogen flow into torch to provide a substantially constant total gas flow into the torch.

In another aspect, a method of sustaining an inductively coupled plasma in a torch comprises introducing a plasma gas flow and a cooling gas flow into the torch an inner tube positioned within an outer tube, the outer tube comprising an inlet and an outlet and at least two cooling gas slots positioned in a common radial plane adjacent to the inlet of the outer tube, wherein the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section, wherein an outer diameter of the first section and the third section are substantially constant in a longitudinal direction, and wherein an outer diameter of the second section increases in the longitudinal direction from the first section toward the third section, and wherein a distance between an outer surface of the third section and an inner surface of the outer tube is less than 1 mm. The method may also comprise sustaining the inductively coupled plasma within the torch using a cooling gas flow introduced concentrically into each of the first and second cooling gas slots at a total cooling gas flow of less than 10 Liters/minute and using a total gas flow into the torch of less than 11 Liters/minute.

Additional aspects, configurations, embodiments and examples are described in more detail below.

### BRIEF DESCRIPTION OF THE SEVERAL VIEWS OF THE DRAWINGS

Certain configurations are described with reference to the accompanying figures in which:

FIG. 1 is an illustration of a torch comprising an outer tube and an inner tube, in accordance with certain examples;

FIGS. 2A and 2B are illustrations of a terminal section of an inner tube, in accordance with certain embodiments;

FIGS. 3A and 3B are illustrations showing various terminal section lengths, in accordance with certain examples;

FIG. 4 is an illustration showing axial and tangential cooling gas flows in a torch, in accordance with certain embodiments;

FIG. 5 is an illustration showing a torch with a second section comprising a linearly increasing diameter from one end to another end, in accordance with certain configurations;

FIG. 6 is an illustration showing a torch with a second section comprising a non-linearly increasing diameter from one end to another end, in accordance with certain configurations;

FIG. 7 is an illustration showing a torch with a stepped second section with an increasing diameter from one end to another end, in accordance with certain configurations;

FIG. 8 is another illustration showing a torch with a stepped second section with an increasing diameter from one end to another end, in accordance with certain configurations;

FIG. 9 is an cross-section of a torch showing a cooling gas inlet or slot in an outer tube, in accordance with certain examples;

FIG. 10 is an cross-section of a torch showing two cooling gas inlets or slots in an outer tube, in accordance with certain examples;

FIGS. 11A, 11B and 11C are illustrations of torches used with glass sleeves to control cooling gas entry, in accordance with some examples;

FIG. 12 is an illustration of a device comprising an induction coil and a torch as described herein, in accordance with certain examples;

FIG. 13 is an illustration of device comprising a plate electrode and a torch as described herein, in accordance with certain examples;

FIG. 14 is an illustration of a device comprising an induction coil comprising a radial fin and a torch as described herein, in accordance with certain examples;

FIG. 15 is a schematic of a mass spectrometer device or system, in accordance with certain embodiments;

FIG. 16 is a schematic of an optical emission spectrometer device or system, in accordance with certain embodiments;

FIG. 17 is a schematic of atomic absorption spectrometer device or system, in accordance with certain embodiments; and

FIG. 18 is an illustration of a torch, in accordance with certain examples.

It will be recognized by the person of ordinary skill in the art, given the benefit of this disclosure, that the relative lengths and sizes in the figures are not necessarily to scale. Further, no particular material or shape is intended to be required unless specified otherwise in connection with a particular figure.

### DETAILED DESCRIPTION

In certain examples, by selecting certain attributes of a plasma torch, velocity of the cooling gas can be increased to achieve a similar cooling efficiency and performance at a lower argon flow rate than those used in conventional plasma torches. For example, using the torches described herein, an argon flow rate of 7-10 liters per minute at up to 1400 Watts of plasma power can be used to sustain a stable plasma. In some examples, conventional torches that operate with 15-18 liter per minutes of argon use a power up to 1600 Watts. While the exact configuration of the torch can vary as described in detail below, in some instances, a gap size between the inner and outer tube of the torch, the length of a restrictive path length, the internal diameter of the cooling gas inlet to the torch, and the distance of these inlets from the end of the torch can be selected and used to sustain a stable plasma at a desired flow rate and power. The exact overall length of the various sections of the torches can vary, and illustrative overall lengths for the torch (from the inlet to the outlet) may be, for example, about 90 mm to about 130 mm.

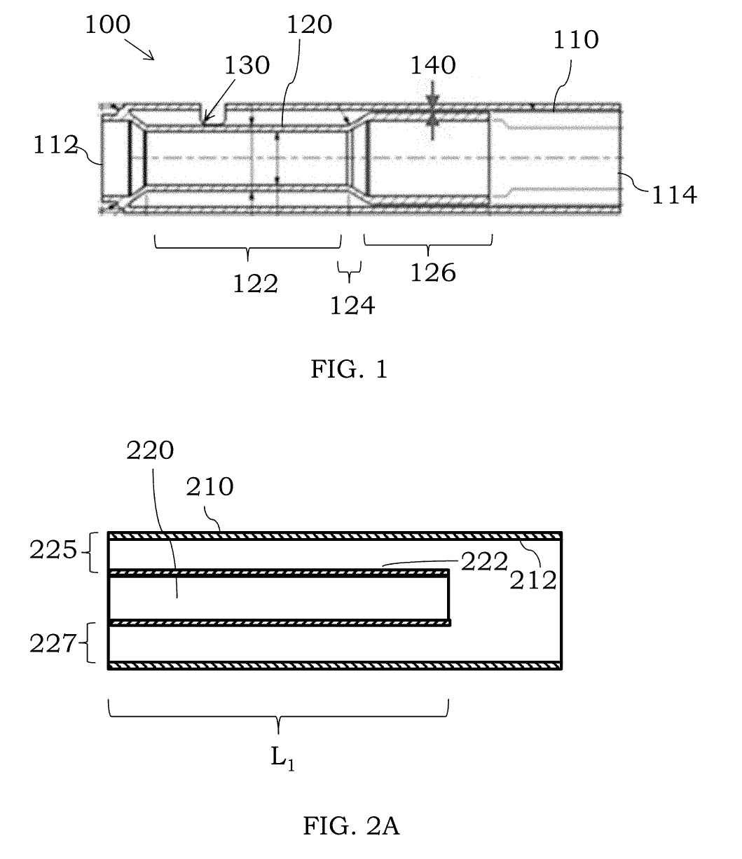

In some embodiments and referring to FIG. 1, a torch 100 comprises an outer tube 110 and an inner tube 120. The inner tube 120 can be coupled to the outer tube 110 at an inlet end 112 through one or more materials, e.g., glass, quartz or the same materials present in the inner tube 120 and/or the outer tube 110 may be used, or the inner and outer tubes may be fused to each other such that their positions are fixed relative to each other. A plasma (not shown) can be sustained within and toward an outlet end 114 of the outer tube 110. A cooling gas can be introduced into the torch 100 through an inlet or slot 130 to prevent the inner tube and/or outer tube from melting due to the high temperature plasma. The cooling gas generally flows in a direction from the inlet end 112 toward the outlet end 114. If desired, a terminal portion of the outer tube 110 may comprise a ceramic, lanthanide or actinide tip to assist in preventing melting of the terminal portion of the outer tube 110 which is typically adjacent to the hot plasma. The inner tube 120 comprises a first section 122, a second section 124 and a third section 126. While these sections are described as being separate for purposes of illustration, the inner tube 120 can be configured as a single integral tube without any defined interfaces or connections between the various sections.

In some examples, a first section 122 of the inner tube 120 comprises an outer diameter which is less than an outer diameter of the third section 126. The outer diameter of the second section 124 transition from being similar to the outer diameter of the first section 122 to being similar to the outer diameter of the third section 126 in a longitudinal direction from the inlet end 112 to the outlet end 114 of the torch 100. As noted in more detail below, this transition may occur linearly, curvilinearly, symmetrically, asymmetrically or in other manner. As the outer diameter of the sections increase, less space is present between an outer surface of the inner tube 120 and an inner surface of the outer tube 110. This space or gap is shown in FIG. 1 as the arrows labeled as element 140. The exact spacing between the inner tube 120 and the outer tune 110 at the gap 140 may be about 0.5 mm or less. Without wishing to be bound by any particular theory, conventional torches typically have a gap spacing of 1 mm or more between the inner tube and the outer tube. By reducing the gap size at gap 140, cooling air velocity can be increased to achieve sufficient cooling at lower cooling gas flow rates, e.g., 10 liters per minute or less. If desired, the gap size can be reduced even further to increase cooling gas flow velocity. While a small gap size, e.g., 0.5 mm or less, can be selected to increase cooling gas velocity, the gap size 140 is desirably not so low such that high cooling gas velocities would disrupt coupling between an induction device (or capacitive device) and the plasma. In some examples, the gap size 140 may be about 0.5 mm to about 0.1 mm or about 0.5 mm to about 0.2 mm or about 0.5 mm to about 0.3 mm or about 0.5 mm to about 0.4 mm or about 0.5 mm, 0.4 mm, 0.3 mm, 0.2 mm or 0.1 mm.

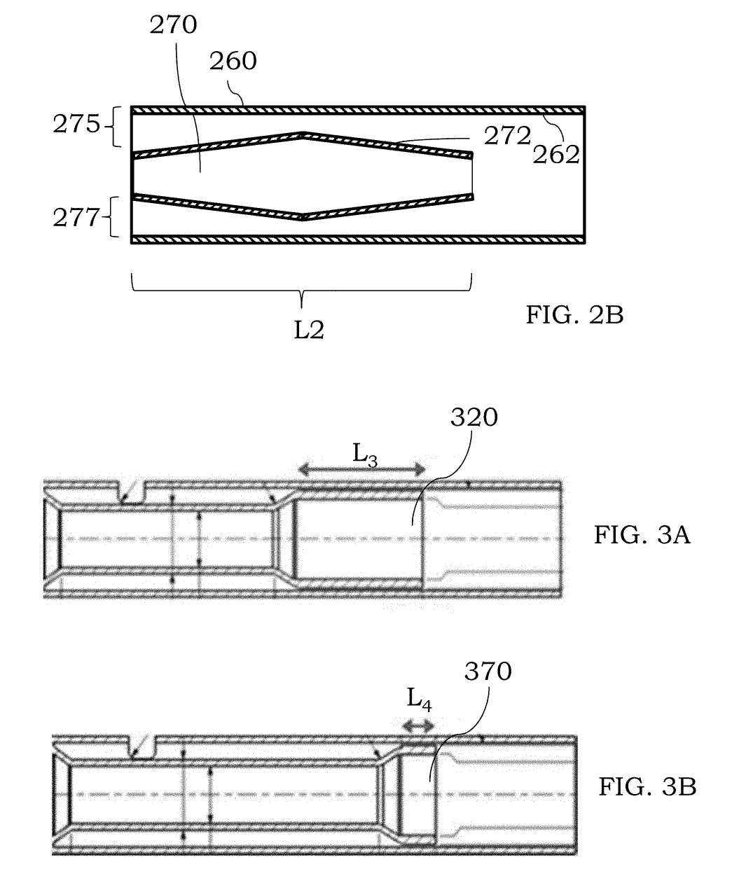

In some examples, the longitudinal gap between outer surfaces of the third section 126 and inner surface of the outer tube 110 may be substantially constant along the entire length of the third section. For example and referring to FIG. 2A, a terminal section of an inner tube 220 is shown as being positioned within an outer tube 210. Gaps 225 between an outer surface 222 of the inner tube 220 and an inner surface 212 of the outer tube 210 is substantially constant along a longitudinal length L₁ of the torch. Similarly, a gap 227 between an outer surface 222 of the inner tube 220 and an inner surface 212 of the outer tube 210 is substantially constant along a longitudinal length L₁ of the torch. While the gaps 225, 227 typically are the same, they could be different if desired. For example, each of the gaps 225, 227 may independently be 0.5 mm to about 0.1 mm or about 0.5 mm to about 0.2 mm or about 0.5 mm to about 0.3 mm or about 0.5 mm to about 0.4 mm. or about 0.5 mm, 0.4 mm, 0.3 mm, 0.2 mm or 0.1 mm.

In certain configurations, the longitudinal gap between the terminal section of the inner tube and inner surfaces of the outer tube may vary along a longitudinal length of the torch. For example and referring to FIG. 2B, a terminal section of an inner tube 270 is shown as being positioned within an outer tube 610. Gaps 225 between an outer surface 272 of the inner tube 270 and an inner surface 262 of the outer tube 260 vary along a longitudinal length L₂ of the torch. Similarly, a gap 277 between an outer surface 262 of the inner tube 270 and an inner surface 262 of the outer tube 260 varies along the longitudinal length L₂ of the torch. While the gaps 275, 277 typically are the same at any radial plane of the torch, they could be different if desired. For example, each of the gaps 275, 277 may independently be 0.5 mm to about 0.1 mm or about 0.5 mm to about 0.2 mm or about 0.5 mm to about 0.3 mm or about 0.5 mm to about 0.4 mm. or about 0.5 mm, 0.4 mm, 0.3 mm, 0.2 mm or 0.1 mm. In some examples, an initial gap may be about 0.5 mm and may taper to a gap of about 0.45 mm or about 0.4 mm along the longitudinal length of the terminal section of the inner tube. By reducing the gap along the longitudinal length of the terminal section of the inner tube, velocity of a cooling gas can be increased to permit a reduction in overall cooling gas volumes.

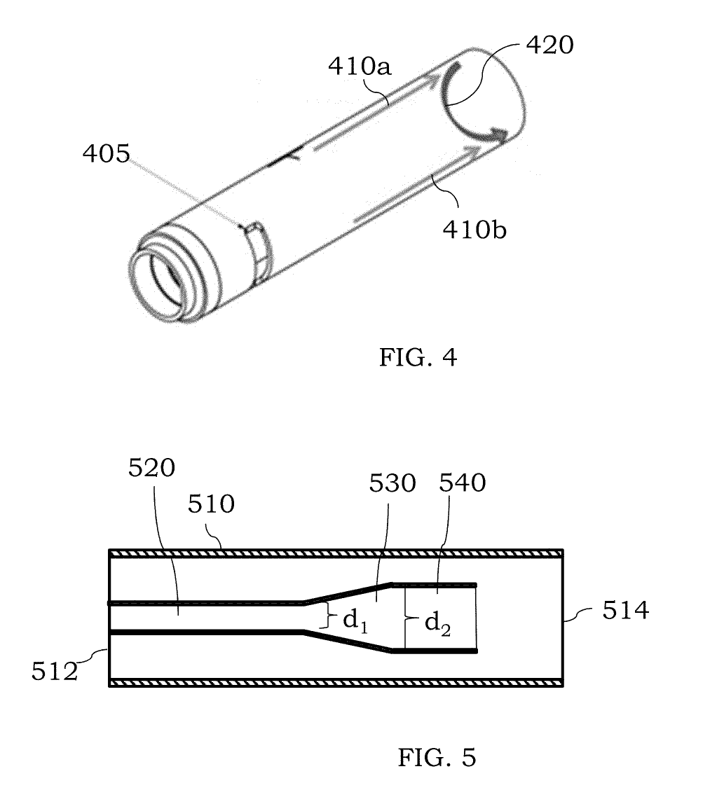

In certain examples, the exact longitudinal length of the third or terminal section of the inner tube can be selected based on a desired cooling gas velocity. For example and referring to FIGS. 3A and 3B, a longitudinal length L₃ of the terminal section 320 may be about 25 mm or less (FIG. 3A). If desired and to further increase velocity through the torch, a longitudinal length of a terminal section 370 may be about 5 mm or less (FIG. 3B). Without wishing to be bound by any particular theory, reducing a length of the terminal section from a length L₃ to a length L₄ can assist in sustaining a tangential flow of cooling gas to improve cooling efficiency. For example and referring to FIG. 4, an illustration showing various cooling gas flows includes an axial flow 410a, 410b and a tangential flow 420. By increasing the tangential flow 420 of cooling gas through the torch, the overall cooling gas flow rate provided to a cooling gas inlet or slot 405 can be reduced while permitting the torch surfaces to remain below a melting temperature and properly sustain a plasma.

In certain examples, the overall shape and length of the second section of the inner tube can be selected to enhance cooling flows through the torch. Referring to FIG. 5, a second section 530 of a torch is shown as increasing in diameter from an inlet end 512 to an outlet end 514 of the outer tube 510 of the torch 500. For example, a diameter d₁ adjacent to a first section 520 of the inner tube may increase linearly to a diameter d₂ adjacent to a third section 540 of the inner tube. The exact increase from d₁ to d₂ may be about 5% to about 20% per mm of longitudinal length. For example, the diameter at d₁ may be about 10 mm to about 16 mm, and the diameter at d₂ may be about 16 mm to about 20 mm. The overall longitudinal length from d₁ to d₂ can vary, for example, from about 4 mm to about 20 mm. As shown in FIG. 5, the increase in diameter is typically symmetrical such that a radial gap distance from the inner surfaces of the outer tube 510 to outer surfaces of the inner tube are about the same around the circumference of any one radial plane of the tubes. If desired, however, the radial gap between inner surfaces of the outer tube and outer surfaces of the inner tube may instead by asymmetric around the circumference of any one radial plane of the tubes.

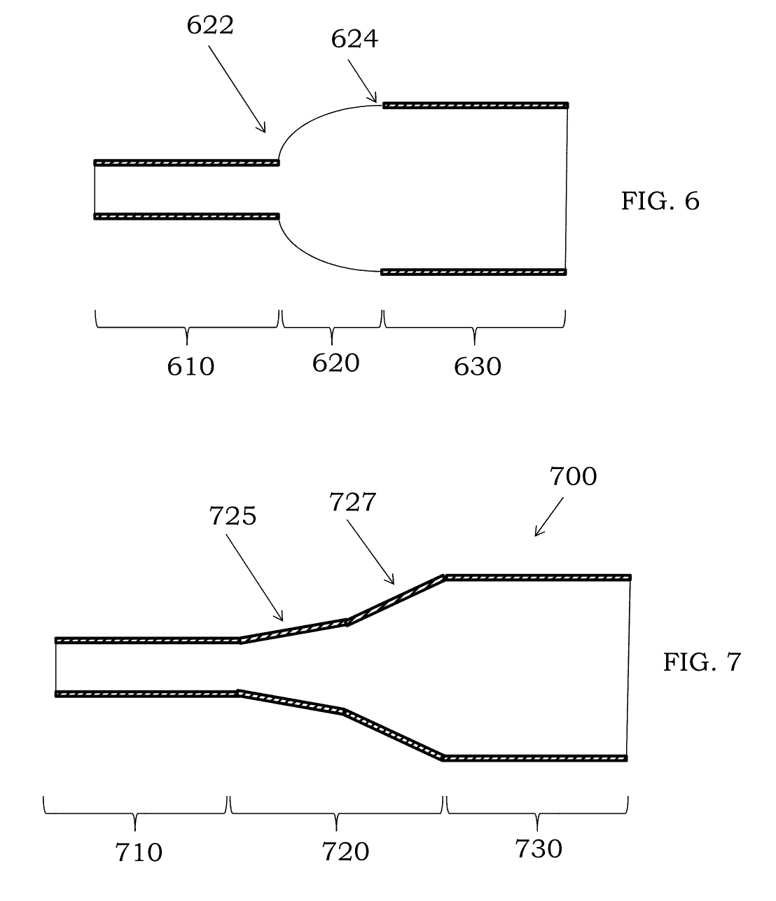

In certain examples, the increase in diameter of the second section need not be linear. For example, the increase can be curvilinear or take other forms than linear. One illustration of an inner tube is shown in FIG. 6 where a diameter of a second section 620 increases in a non-linear manner from a first end 622 (adjacent to a first section 610) to a second end 624 (adjacent to a third section 630). By increasing the diameter from the first end 622 to the second end 624 in a non-linear manner, velocity of cooling gas, and/or cooling gas flow rate, can be further controlled or tuned. While the illustration in FIG. 6 shows a symmetrical increase in diameter at any selected radial plane, an asymmetric increase in diameter could instead be used if desired.

In another configuration, the increase in diameter of the second section may be stepped to permit further control of cooling gas velocity and/or cooling gas air flow rates. Referring to FIG. 7, an inner tube 700 is shown that comprises a second section 720 which comprises stepped sections 725, 727. The percentage increase in diameter from an inlet of section 725 (adjacent to the first section 710) toward the third section 730 is different than the percentage increase in diameter from an inlet of section 727 toward the third section 720 even though an increase in diameter within each of the sections 725, 727 is substantially linear.

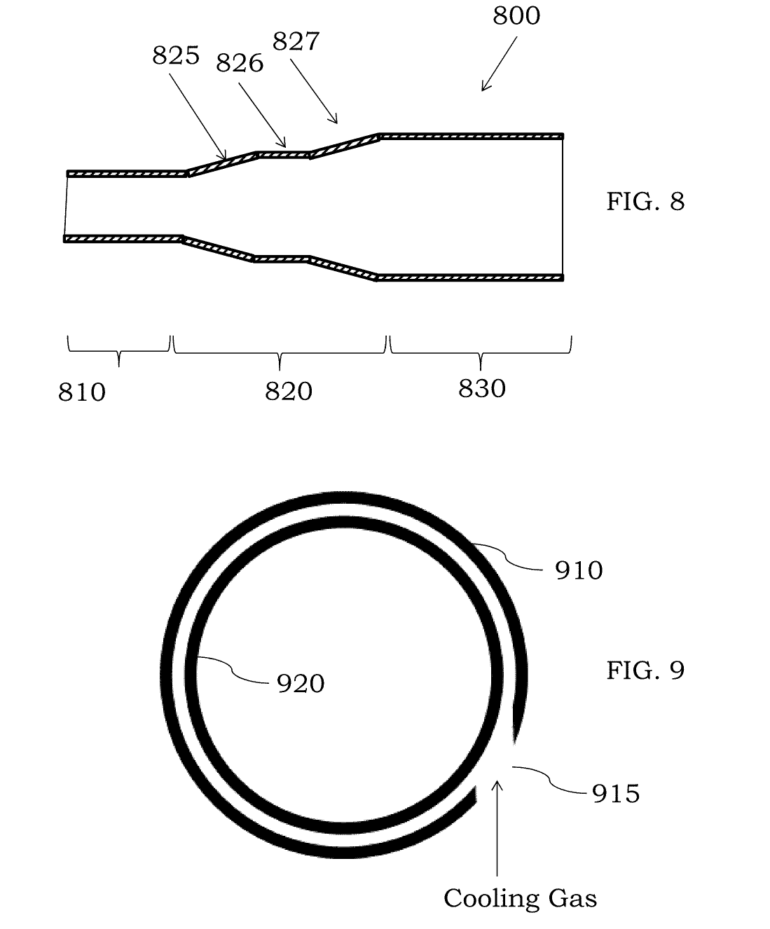

In an additional configuration, a second section may be stepped with one or more steps being substantially parallel to each other. For example and referring to FIG. 8, an inner tube 800 is shown comprising sections 810, 820 and 830. The second section 820 is split into three steps 825, 826 and 827. The diameter increases in step 825 from the first section 810 toward the third section 830. The diameter is substantially constant at step 826 along the longitudinal length. At step 827, the diameter increases toward the third section 830. By selecting various step lengths and sizes, the velocity of cooling gas can be further controlled and/or tuned. While the steps in FIG. 8 are shown as having a linearly increasing diameter along the longitudinal length of the tube 800, if desired non-linear increases in diameter could also be used, e.g., in combination with a linear increase in diameter in one or more steps or in combination with a non-linear increase in diameter of one or more steps.

In certain embodiments, the overall longitudinal length of the other sections of the inner tube may vary as desired. For example, the first section can be about 35 mm to about 55 mm in length and comprise an outer diameter of about 10 mm to about 16 mm. The third section may comprise, for example, a longitudinal length of about 5 mm to about 25 mm and comprise an outer diameter of about 16 mm to about 18 mm.

While the exact material used in the outer tube and the inner tube can vary, the melting temperature of the torch materials is typically lower than the temperatures of the plasma sustained in the torch. In some examples, the torch may comprise quartz, high purity quartz, ceramics or other materials as desired. The materials in the inner tube and the outer tube may be the same or may be different. In some instances, materials in different sections of the inner tube may be different. For example, one or more sections of the inner tube may comprise quartz and another one or more sections of the inner tube may comprise a ceramic, lanthanide or actinide material.

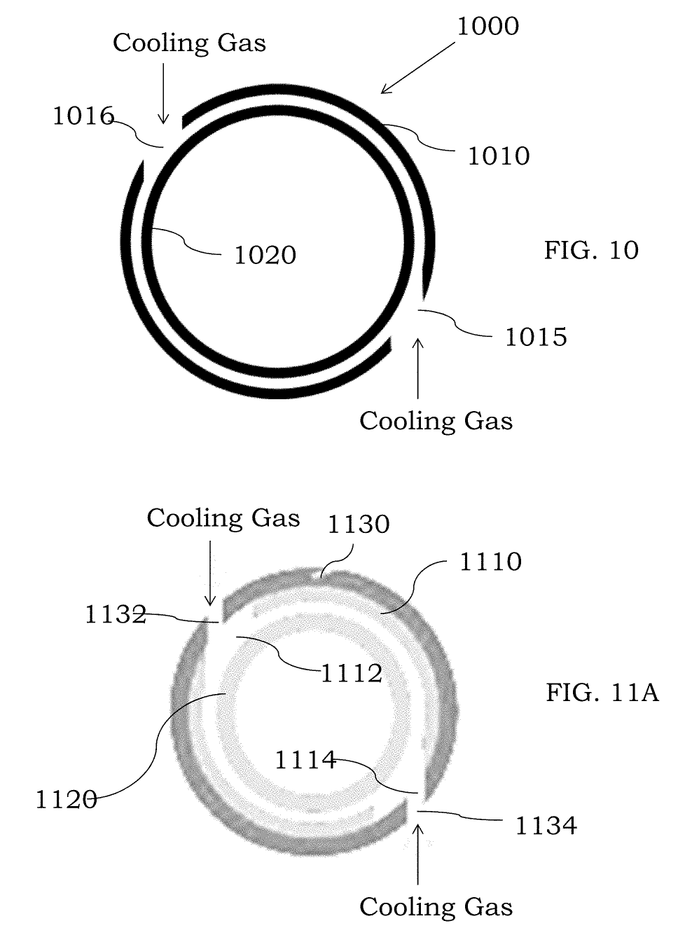

In some configurations, the outer tube of the torches described herein may comprise one or more cooling slots to provide a cooling gas into the torch. For example, the cooling slot 405 in FIG. 4 can be fluidically coupled to a cooling gas source, e.g., argon, nitrogen, air, etc. to provide a cool gas flow, e.g., axial and/or tangential flows, within the torch to prevent the torch from melting. The cooling gas is typically introduced to provide a circumferential flow in the torch to enhance cooling. For example and referring to FIG. 9, a cooling gas can be provided through an inlet 915 in the outer tube 910 to cool the outer tube 910 and the inner tube 920. The introduction of the cooling gas may also assist in providing a concentric plasma in the torch. If desired, a second cooling inlet can be present in the outer tube to further enhance a concentric plasma. Referring to FIG. 10, a torch 1000 is shown that comprises an outer tube 1010, an inner tube 1020 and cooling inlets or slots 1015, 1016. Where two cooling slots are present, the cooling gas can be introduced in a concentric flow to further enhance tangential flows in the torch 1000. If desired, a counter concentric flow could be provided for some period to alter the overall flows within the torch, e.g., by introducing cooling air through the slot 1016 in a counter flow from the direction cooling air is introduced through the slot 1015. In some example, the cooling gas introduced through the slot 1015 may be different from that introduced through the slot 1016. For example, argon cooling gas can be introduced through the slot 1015, the plasma may be ignited, and then a different cooling gas, e.g., air, nitrogen, etc. can be introduced into the slot 1016 with the flow rate of argon introduced into the slot 1015 being reduced to a lower level. The exact positioning of the second cooling slot 1016 may vary, and in some examples, the second cooling slot may be positioned in the same radial plane as the first cooling slot 1015, whereas in other examples, the second cooling slot 1016 can be positioned in a radial plane downstream or upstream from a radial plane where the first cooling slot 1015 is positioned. Further, while the cooling gas slots 915, 1015, 1016 are shown as generally having a slot-like shape, other shapes such as circular, square, rectangular, etc. may be used instead, and the exact shape or cross-section of one particular slot need not be the same as the other slot(s). In addition, more than two cooling gas slots can also be present if desired.

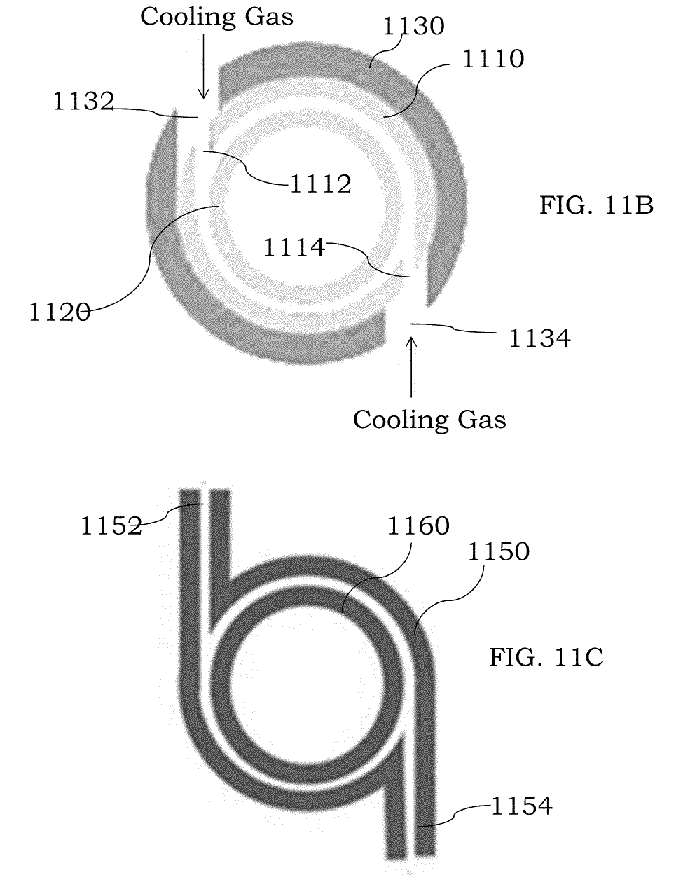

In certain examples, overall cooling gas flow into the torch can be further controlled using a sleeve or tube reversibly coupled to the torch. Various configurations are shown in FIGS. 11A-11C. Referring to FIG. 11A, a torch comprises an outer tube 1110 with cooling gas slots 1112, 1114 and an inner tube 1020. A glass sleeve 1130 wraps around the outer tube 1110 and comprises slots 1132, 1134. In this configuration, the slots 1112, 1114 of the outer tube 1110 are generally aligned with the slots 1132, 1134, respectively of the glass sleeve 1130. In other configurations (see FIG. 11B), the slots 1132, 1134 can be offset to some extent to better control cooling gas flows into the torch. During use, the sleeve 1130 can be rotated circumferentially to control how much the various slots are aligned or misaligned. In other configurations (FIG. 11C), a torch may comprise an inner tube 1160 and an outer tube 1150 comprising gas inlets 1152, 1154. The inner diameter of the gas inlets 1152, 1154 are fixed.

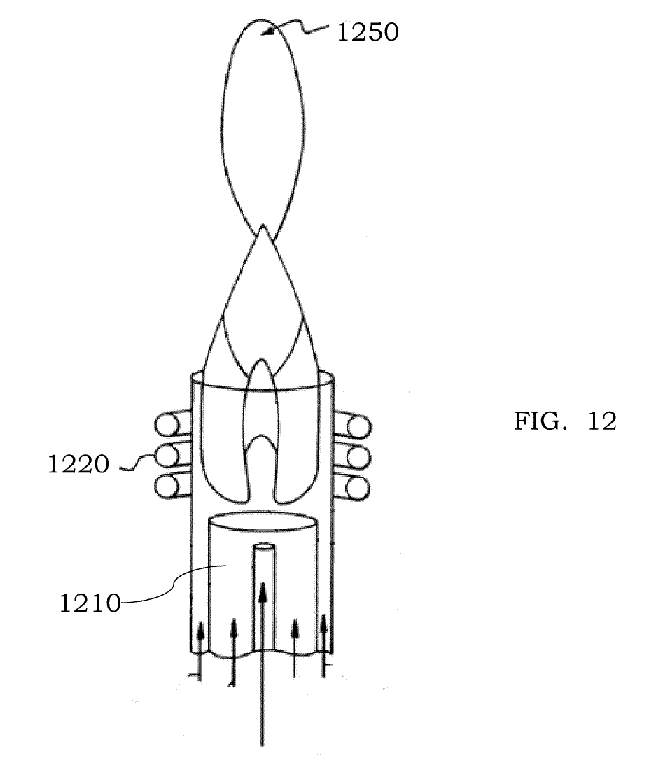

In certain examples, the torches described herein can be used in many different systems and devices. If desired, the system may comprise one or more induction devices such as those described, for example, in U.S. Pat. Nos. 9,433,073 and 9,360,403, the entire disclosure of which is hereby incorporated herein by reference for all purposes. Referring to FIG. 12, a device comprising a torch 1210 as described herein in combination with an induction coil 1220 is shown. The induction coil 1220 is typically electrically coupled to a radio frequency generator (not shown) to provide radio frequency energy into the torch 1210 and sustain an inductively coupled plasma 1250. The torch 1210 may be configured similar to any of the torches described herein to permit the plasma 1250 to be sustained at low flow rates, e.g., 12 liters per minute or less total gas flows with 10 liters per minute or less cooling gas flows. For example, the torch 1210 may comprise an outer tube comprising an inlet, an outlet and at least one cooling gas slot adjacent to the inlet of the outer tube. In certain examples, the torch 1210 comprises an inner tube positioned within the outer tube. In some configurations, the inner tube of the torch 1210 further comprises a first section coupled to a second section and a third section coupled to the second section. In some instances, the first section of the inner tube of the torch 1210 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1210 are substantially constant in a longitudinal direction. In some examples, an outer diameter of the second section of the inner tube of the torch 1210 increases in the longitudinal direction from the first section toward the third section. In certain configurations, a distance between an outer surface of the third section of the inner tube of the torch 1210 and an inner surface of the outer tube of the torch 1210 is less than 1 mm, e.g., 0.5 mm or less.

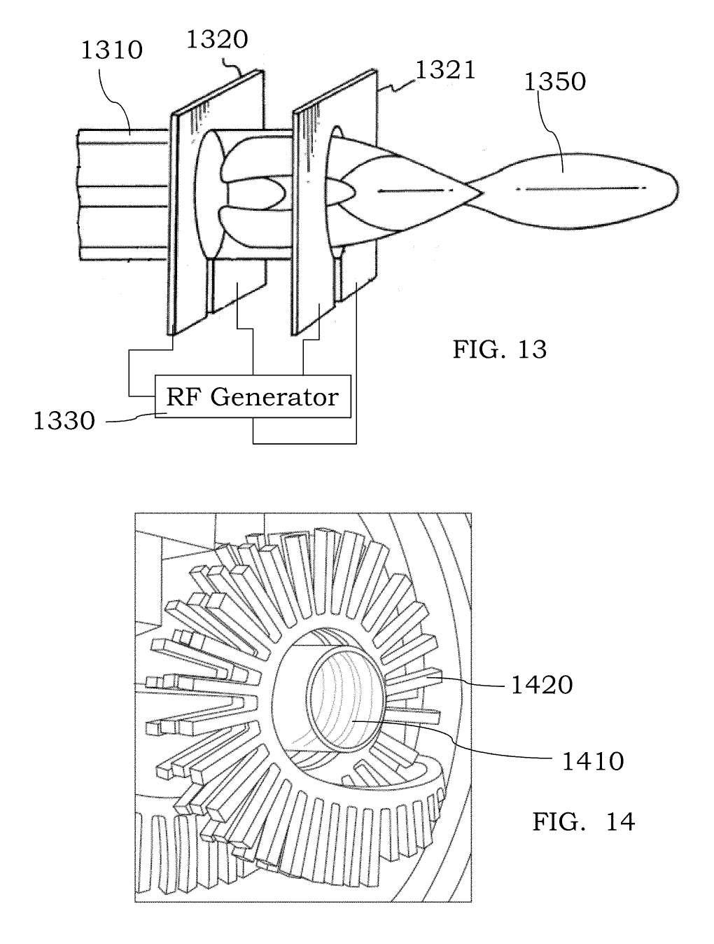

In an alternative configuration, the induction coil 1220 could be replaced with one or more plate electrodes. For example and referring to FIG. 13, a first plate electrode 1320 and a second plate electrode 1321 are shown as comprising an aperture that can receive a torch 1310 as described herein. For example, the torch 1310 can be placed within some region of an induction device comprising plate electrodes 1320, 1321. A plasma or other ionization/atomization source 1350 such as, for example, an inductively coupled plasma can be sustained using the torch 1310 and inductive energy from the plates 1320, 1321. A radio frequency generator 1330 is shown as electrically coupled to each of the plates 1320, 1321. If desired, only a single plate electrode could be used instead. Where one, two, three or more plate electrodes are used in combination with a torch, the torch may take any of the configurations described herein. For example, the torch 1310 may comprise an outer tube comprising an inlet, an outlet and at least one cooling gas slot adjacent to the inlet of the outer tube. In certain examples, the torch 1310 comprises an inner tube positioned within the outer tube. In some configurations, the inner tube of the torch 1310 further comprises a first section coupled to a second section and a third section coupled to the second section. In some instances, the first section of the inner tube of the torch 1310 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1310 are substantially constant in a longitudinal direction. In some examples, an outer diameter of the second section of the inner tube of the torch 1310 increases in the longitudinal direction from the first section toward the third section. In certain configurations, a distance between an outer surface of the third section of the inner tube of the torch 1310 and an inner surface of the outer tube of the torch 1310 is less than 1 mm, e.g., 0.5 mm or less.

In other configurations, an induction device comprising one or more radial fins could instead be used with the torches described herein. Referring to FIG. 14, a device or system may comprise an induction coil 1420 comprising at least one radial fin and a torch 1410 as described herein. A plasma or other ionization/atomization source (not shown) such as, for example, an inductively coupled plasma can be sustained using the torch 1410 and inductive energy from the radially finned induction device 1420. A radio frequency generator (not shown) can be electrically coupled to the induction device 1420 to provide radio frequency energy into the torch 1410. The torch 1410 may take any of the configurations described herein. In certain configurations, the torch 1410 comprises an inner tube positioned within the outer tube. In some configurations, the inner tube of the torch 1410 further comprises a first section coupled to a second section and a third section coupled to the second section. In some instances, the first section of the inner tube of the torch 1410 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1410 are substantially constant in a longitudinal direction. In some examples, an outer diameter of the second section of the inner tube of the torch 1410 increases in the longitudinal direction from the first section toward the third section. In certain configurations, a distance between an outer surface of the third section of the inner tube of the torch 1410 and an inner surface of the outer tube of the torch 1410 is less than 1 mm, e.g., 0.5 mm or less.

In other instances, one or more capacitive device such as, for example, capacitive coils or capacitive plates can be used in combination with the torches describes herein. Further two or more induction device, capacitive device or other devices which can provide energy into the torch to sustain an atomization/ionization source such as a plasma or flame can also be used.

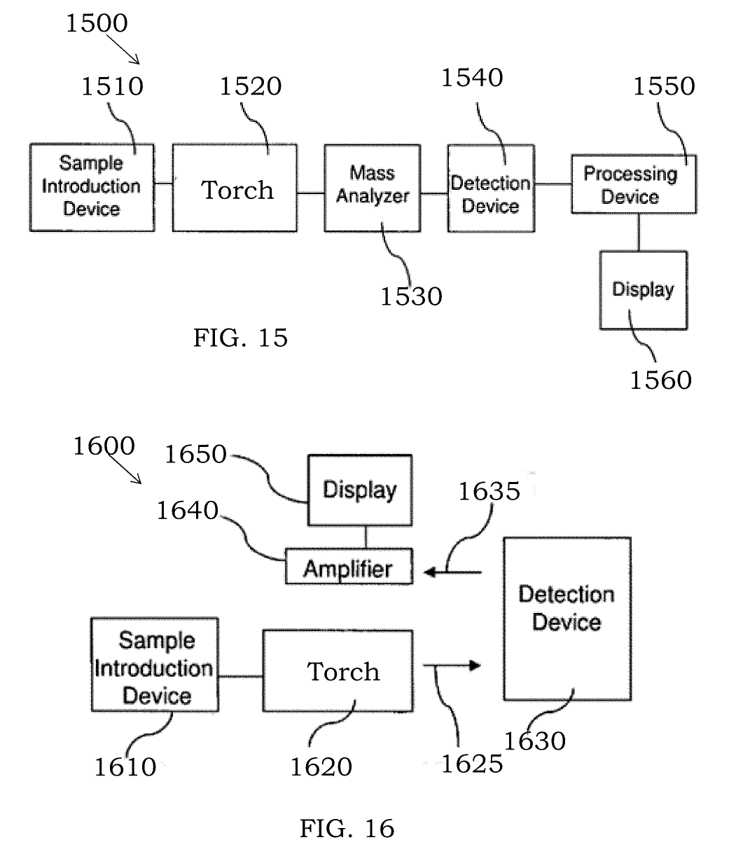

In certain configurations, the torches described herein can be used in a system configured to perform mass spectrometry (MS). For example and referring to FIG. 15, a MS device or system 1500 includes a sample introduction device 1510, a torch 1520 as described herein that can be used to sustain an atomization/ionization source, a mass analyzer 1530, a detector or detection device 1540, a processing device 1550 and a display 1560. The sample introduction device 1510, the torch 1520, the mass analyzer 1530 and the detection device 1540 may be operated at reduced pressures using one or more vacuum pumps. In certain examples, however, only the mass analyzer 1530 and the detection device 1540 may be operated at reduced pressures. The sample introduction device 1510 may include an inlet system configured to provide sample to the torch 1520. The inlet system may include one or more batch inlets, direct probe inlets and/or chromatographic inlets. The sample introduction device 1510 may be an injector, a nebulizer or other suitable devices that may deliver solid, liquid or gaseous samples to the torch 1520. The torch 1520 can be used in combination with any one of or more of the induction devices described herein. The mass analyzer 1530 may take numerous forms depending generally on the sample nature, desired resolution, etc. and exemplary mass analyzers may comprise one or more rod assemblies such as, for example, a quadrupole or other rod assembly. In some instances, the mass analyzer 1530 may comprise its own radio frequency generator. The detection device 1540 may be any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure. The processing device 1550 typically includes a microprocessor and/or computer and suitable software for analysis of samples introduced into the MS device 1500. One or more databases may be accessed by the processing device 1550 for determination of the chemical identity of species introduced into the MS device 1500. Other suitable additional devices known in the art may also be used with the MS device 1500 including, but not limited to, autosamplers, such as AS-90plus and AS-93plus autosamplers commercially available from PerkinElmer Health Sciences, Inc. It will also be within the ability of the person of ordinary skill in the art, given the benefit of this disclosure, to retrofit existing MS devices with the torches described herein and to design new MS devices using the torches described herein. For example, the torch 1510 may take any of the configurations described herein. In certain configurations, the torch 1510 comprises an inner tube positioned within the outer tube. In some configurations, the inner tube of the torch 1510 further comprises a first section coupled to a second section and a third section coupled to the second section. In some instances, the first section of the inner tube of the torch 1510 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1510 are substantially constant in a longitudinal direction. In some examples, an outer diameter of the second section of the inner tube of the torch 1510 increases in the longitudinal direction from the first section toward the third section. In certain configurations, a distance between an outer surface of the third section of the inner tube of the torch 1510 and an inner surface of the outer tube of the torch 1510 is less than 1 mm, e.g., 0.5 mm or less.

In certain configurations, the torches described herein can be used in optical emission spectroscopy (OES). Referring to FIG. 16, an OES device or system 1600 includes a sample introduction device 1610, a torch 1620 as described herein and optionally comprising one or more induction devices, and a detection device 1630. The sample introduction device 1610 may vary depending on the nature of the sample. In certain examples, the sample introduction device 1610 may be a nebulizer that is configured to aerosolize liquid sample for introduction into the torch 1620. In other examples, the sample introduction device 1610 may be an injector configured to receive sample that may be directly injected or introduced into the torch 1620. Other suitable devices and methods for introducing samples will be readily selected by the person of ordinary skill in the art, given the benefit of this disclosure. The detector or detection device 1630 may take numerous forms and may be any suitable device that may detect optical emissions, such as optical emission 1625. For example, the detection device 1630 may include suitable optics, such as lenses, mirrors, prisms, windows, band-pass filters, etc. The detection device 1630 may also include gratings, such as echelle gratings, to provide a multi-channel OES device. Gratings such as echelle gratings may allow for simultaneous detection of multiple emission wavelengths. The gratings may be positioned within a monochromator or other suitable device for selection of one or more particular wavelengths to monitor. In certain examples, the detection device 1630 may include a charge coupled device (CCD). In other examples, the OES device 1600 may be configured to implement Fourier transforms to provide simultaneous detection of multiple emission wavelengths. The detection device 1630 may be configured to monitor emission wavelengths over a large wavelength range including, but not limited to, ultraviolet, visible, near and far infrared, etc. The OES device 1600 may further include suitable electronics such as a microprocessor and/or computer and suitable circuitry to provide a desired signal and/or for data acquisition. Suitable additional devices and circuitry are known in the art and may be found, for example, on commercially available OES devices such as Optima 2100DV series, Optima 5000 DV series OES devices or Optima 8000 or 8300 series OES devices commercially available from PerkinElmer Health Sciences, Inc. The optional amplifier 1640 e.g., a photomultiplier tube, may be operative to increase a signal 1635, e.g., amplify the signal from detected photons, and provides the signal to display 1650, which may be a readout, computer, etc. In examples where the signal 1635 is sufficiently large for display or detection, the amplifier 1640 may be omitted. In certain examples, the amplifier 1640 is a photomultiplier tube (PMT) configured to receive signals from the detection device 1630. Other suitable devices for amplifying signals, however, will be selected by the person of ordinary skill in the art, given the benefit of this disclosure. If desired the PMT can be integrated into the detector 1630. It will also be within the ability of the person of ordinary skill in the art, given the benefit of this disclosure, to retrofit existing OES devices with the torches disclosed here and to design new OES devices using the torches disclosed here. The OES devices may further include autosamplers, such as AS90 and AS93 autosamplers commercially available from PerkinElmer Health Sciences, Inc. or similar devices available from other suppliers. In some examples, the torch 1620 used with an OES device 1600 may comprise any of the configurations described herein. In certain configurations, the torch 1620 comprises an inner tube positioned within the outer tube. In some configurations, the inner tube of the torch 1620 further comprises a first section coupled to a second section and a third section coupled to the second section. In some instances, the first section of the inner tube of the torch 1620 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1620 are substantially constant in a longitudinal direction. In some examples, an outer diameter of the second section of the inner tube of the torch 1620 increases in the longitudinal direction from the first section toward the third section. In certain configurations, a distance between an outer surface of the third section of the inner tube of the torch 1620 and an inner surface of the outer tube of the torch 1620 is less than 1 mm, e.g., 0.5 mm or less.

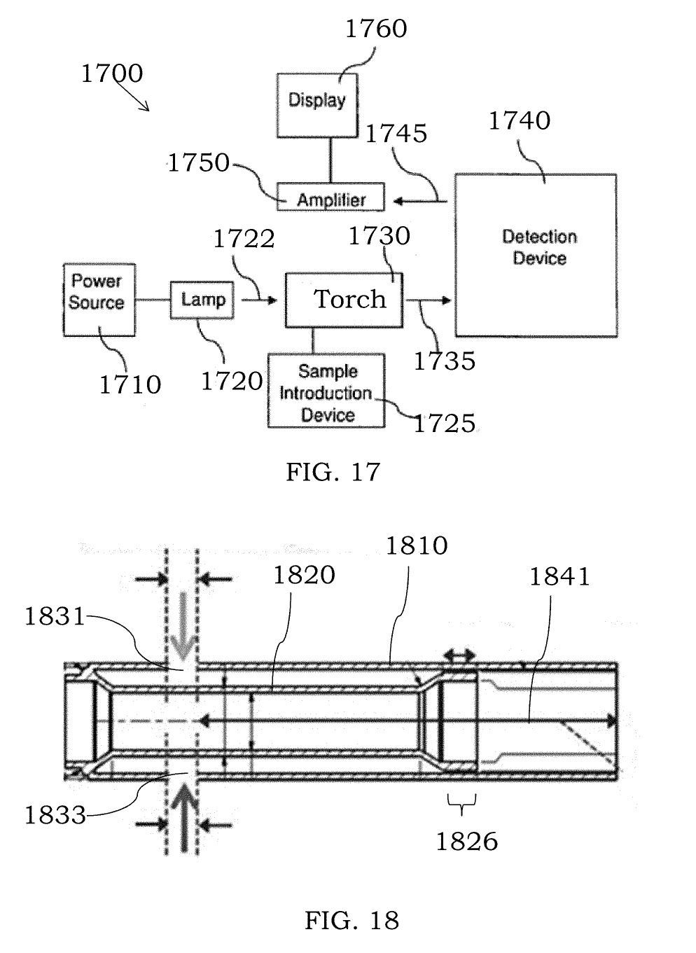

In certain examples, the torches described herein can be used in an atomic absorption spectrometer (AAS). Referring to FIG. 17, a single beam AAS 1700 comprises a power source 1710, a lamp 1720, a sample introduction device 1725, a torch 1730 as described herein, a detector or detection device 1740, an optional amplifier 1750 and a display 1760. The power source 1710 may be configured to supply power to the lamp 1720, which provides one or more wavelengths of light 1722 for absorption by atoms and ions. Suitable lamps include, but are not limited to mercury lamps, cathode ray lamps, lasers, etc. The lamp may be pulsed using suitable choppers or pulsed power supplies, or in examples where a laser is implemented, the laser may be pulsed with a selected frequency, e.g. 5, 10, or 20 times/second. The exact configuration of the lamp 1720 may vary. For example, the lamp 1720 may provide light axially along the torch 1730 or may provide light radially along the torch 1730. The example shown in FIG. 17 is configured for axial supply of light from the lamp 1720. There can be signal-to-noise advantages using axial viewing of signals. The torch 1730 may be any of the torches described herein optionally in combination with an induction device as described herein. As sample is atomized and/or ionized in the torch 1730, the incident light 1722 from the lamp 1720 may excite atoms. That is, some percentage of the light 1722 that is supplied by the lamp 1720 may be absorbed by the atoms and ions in the torch 1730. The remaining percentage of the light 1735 may be transmitted to the detection device 1740. The detection device 1740 may provide one or more suitable wavelengths using, for example, prisms, lenses, gratings and other suitable devices such as those discussed above in reference to the OES devices, for example. The signal may be provided to the optional amplifier 1750 for increasing the signal provided to the display 1760. To account for the amount of absorption by sample in the torch 1730, a blank, such as water, may be introduced prior to sample introduction to provide a 100% transmittance reference value. The amount of light transmitted once sample is introduced into the torch 1730 may be measured, and the amount of light transmitted with sample may be divided by the reference value to obtain the transmittance. The negative log₁₀ of the transmittance is equal to the absorbance. AAS device 1700 may further include suitable electronics such as a microprocessor and/or computer and suitable circuitry to provide a desired signal and/or for data acquisition. Suitable additional devices and circuitry may be found, for example, on commercially available AAS devices such as AAnalyst series spectrometers or PinAAcle spectrometers commercially available from PerkinElmer Health Sciences, Inc. It will also be within the ability of the person of ordinary skill in the art, given the benefit of this disclosure, to retrofit existing AAS devices with the torches disclosed here and to design new AAS devices using the torches disclosed here. The AAS devices may further include autosamplers known in the art, such as AS-90A, AS-90plus and AS-93plus autosamplers commercially available from PerkinElmer Health Sciences, Inc. Where the torch 1730 is configured to sustain an inductively coupled plasma, a radio frequency generator electrically coupled to an induction device may be present. In certain embodiments, a double beam AAS device, instead of a single beam AAS device could instead be used. In certain configurations, the torch 1730 comprises an inner tube positioned within the outer tube. In some configurations, the inner tube of the torch 1730 further comprises a first section coupled to a second section and a third section coupled to the second section. In some instances, the first section of the inner tube of the torch 1730 is positioned adjacent to the inlet of the outer tube and the third section is positioned downstream from the second section toward the outlet of the outer tube and the second section is between the first section and the third section. In certain embodiments, an outer diameter of the first section and the third section of the inner tube of the torch 1730 are substantially constant in a longitudinal direction. In some examples, an outer diameter of the second section of the inner tube of the torch 1730 increases in the longitudinal direction from the first section toward the third section. In certain configurations, a distance between an outer surface of the third section of the inner tube of the torch 1730 and an inner surface of the outer tube of the torch 1730 is less than 1 mm, e.g., 0.5 mm or less.

Certain specific examples are described to further illustrate the technology described herein.

### Example 1

In certain embodiments and referring to FIG. 18, a high purity quartz torch can be produced with a quartz inner tube 1820 fused to a quartz outer tube 1810. A length of a third section 1826 may vary from about 5 mm to about 25 mm. A gap distance between the outer tube and the inner tube may be about 0.4 mm to about 0.5 mm at the third section 1826. A distance from the end of the outer tube to the inlet of the torch (shown as the arrow labeled as element 1841) may be from about 25 mm to about 80 mm. An overall length of the torch from the inlet to the outlet may be about 90 mm to about 130 mm. Two cooling gas inlets or slots 1831, 1833 are present in the outer tube 1820. The cooling gas inlets or slots may comprise an inner diameter of about 0.2 mm to about 1 mm. The torch can be operated up to about 1400 Watts RF power with a cooling argon gas flow of about 8-10 liters/minute depending on the sample type.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A torch configured to sustain an ionization source, the torch comprising:
an outer tube comprising an inlet, an outlet and at least one cooling gas slot adjacent to the inlet of the outer tube; and
an inner tube positioned within the outer tube, the inner tube further comprising a first section coupled to a second section and a third section coupled to the second section, wherein the first section is positioned adjacent to the inlet of the outer tube and the third section is positioned downstream from the second section toward the outlet of the outer tube and the second section is between the first section and the third section, wherein an outer diameter of the first section and the third section are substantially constant in a longitudinal direction, and wherein an outer diameter of the second section increases in the longitudinal direction from the first section toward the third section, and wherein a distance between an outer surface of the third section and an inner surface of the outer tube is less than 1 mm.

2. The torch of claim 1, wherein the second section comprises a substantially symmetric radial cross-section along the longitudinal length.

3. The torch of claim 1, further comprising a second cooling gas slot in the outer tube.

4. The torch of claim 3, wherein the first cooling gas slot and the second cooling gas slot are positioned in a same radial plane.

5. The torch of claim 1, wherein the outer diameter of the third section is greater than the outer diameter of the first section.

6. The torch of claim 1, wherein a longitudinal length of the third section is 25 mm or less.

7. The torch of claim 1, wherein a longitudinal length of the third section is 5 mm or less.

8. The torch of claim 1, wherein a longitudinal length of the third section is 5 mm or less and the distance between the outer surface of the third section and the inner surface of the outer tube is 0.5 mm or less.

9. The torch of claim 1, wherein a longitudinal length of the third section is selected to provide a concentric inductively coupled plasma in the torch.

10. The torch of claim 1, wherein a distance between the cooling gas slot and the outlet of the outer tube is between 25 mm and 80 mm.

11. The torch of claim 1, wherein the outer diameter of the second section increases from a first end adjacent to the first section to a second end adjacent to the third section.

12. The torch of claim 11, wherein the outer diameter of the second section is about 12 mm at the first end and about 17 mm at the second end.

13. The torch of claim 12, wherein a longitudinal length of the third section is about 25 mm or less.

14. The torch of claim 13, wherein the distance between the outer surface of the third section and the inner surface of the outer tube varies along a longitudinal length of the third section.

15. The torch of claim 1, wherein the first section is about 35 mm to about 55 mm in length and comprises an outer diameter of about 10 mm to about 16 mm, wherein the third section is about 5 mm to about 25 mm in length and comprises an outer diameter of about 16 mm to about 18 mm, and wherein the second section comprises a length of about 4 mm to about 20 mm.

16. A method of sustaining an ionization source in a torch using a cooling gas flow of 10 Liters/minute or less, the method comprising providing radio frequency energy into a torch from an induction device to sustain the ionization source in the torch at the cooling gas flow rate of 10 Liters/minute or less, the torch comprising an inner tube positioned within an outer tube, the outer tube comprising an inlet and an outlet and at least one cooling gas slot adjacent to the inlet of the outer tube, wherein the inner tube comprises a first section coupled to a second section and a third section coupled to the second section, wherein the first section is positioned adjacent to the inlet of the outer tube and the third section is positioned downstream from the second section toward the outlet of the outer tube and the second section is between the first section and the third section, wherein an outer diameter of the first section and the third section are substantially constant in a longitudinal direction, and wherein an outer diameter of the second section increases in the longitudinal direction from the first section toward the third section, and wherein a distance between an outer surface of the third section and an inner surface of the outer tube is less than 1 mm.

17. The method of claim 16, further comprising providing the radio frequency energy into the torch at a power up to about 1400 Watts.

18. The method of claim 16, further comprising configuring the outer tube with a second cooling gas slot to sustain a substantially concentric plasma within the torch, wherein the total cooling gas flow rate introduced into the first and second cooling gas slots is 10 Liters/minute or less.

19. The method of claim 18, further comprising concentrically introducing the cooling gas into the first and second cooling gas slots.

20. The method of claim 18, further comprising introducing the cooling gas into the second cooling gas slot after the plasma is ignited in the torch.

21-71. (canceled)
